(19) United States
(12) Patent Application Publication
(10) Pub. No.: US 2023/0348702 A1
(43) Pub. Date: Nov. 2, 2023

(54) COMPOSITIONS WHICH HAVE POLYESTER-POLYSILOXANE COPOLYMERS

(71) Applicant: Wacker Chemie AG, Munich (DE)

(72) Inventors: Oliver SCHÄFER, Burghausen (DE); Katja HÜTTL, Julbach (DE); Michael JOACHIMBAUER, Gumpersdorf (DE)

(73) Assignee: Wacker Chemie AG, Munich (DE)

(21) Appl. No.: 17/914,178

(22) PCT Filed: Mar. 24, 2020
(86) PCT No.: PCT/EP2020/058243

§ 371 Date: Sep. 23, 2022

(51) Int. Cl. C08L 23/06; C08L 23/12; C08G 77/445

(52) U.S. Cl. CPC C08L 23/06; C08L 23/12; C08G 77/445; C08L 2207/062; C08L 2203/30; C08L 2201/08; C08L 2201/02

(57) ABSTRACT

Compositions having polyester-polysiloxane copolymers, containing (A) polyolefins which can optionally be substituted and (B) at least one organosilicon compound of the general formula R3-a-b(OR1)aR2 bSi[OSiR2]p[OSiRR2]q[OSiR2 2]rOSiR3-a-b(OR1)aR2 b (I). Along with methods of making the same and products made from the same.

The invention relates to compositions comprising polyester-polysiloxane copolymers, to the production thereof, and to the use thereof.

Thermoplastic polyolefins such as polyethylene or polypropylene nowadays account for the lion's share of plastics produced worldwide. In recent years, advances in manufacturing technology for these polymers have made possible increasingly high-performance materials. Despite the inherently good processing properties of polyolefins, their processing still requires the use of process additives to optimize properties such as processing speed, surface quality, mold-release behavior, rheology control, and others. Besides more oligomeric additives such as fatty acid amides, fatty acid esters, metal stearates, oligomeric hydrocarbon waxes (PE waxes), use is also made of higher-molecular-weight polymers such as fluoropolymers. A challenge here is to minimize as far as possible the use of these process additives so as to minimize any adverse effect on other material properties of polyolefins, such as stiffness or scratch resistance, while at the same time maximizing the desired effect in the particular case, such as increasing processing speed. There has accordingly been a search for new additive concepts that show increased effectiveness compared to products used in the prior art.

Polyester-polysiloxane copolymers can be classified according to a variety of methods. For instance, they may be differentiated chemically into the group of aliphatic polyester-polysiloxane copolymers and the group of aromatic polyester-polysiloxane copolymers. Aliphatic polyester-polysiloxane copolymers have the advantage of simpler chemical synthesis as well as the advantage of lower processing and synthesis temperatures. There is consequently a general preference for aliphatic polyester-polysiloxane copolymers.

Copolymers can additionally be further subdivided into the group of linearly modified polyester-polysiloxane block copolymers and the group of side-chain modified polyester-polysiloxane graft copolymers. Linear variants can be formed in a chemically selective manner, whereas copolymers modified in the polymer side chain have the advantage of greater chemical variability.

Polyester-polysiloxane copolymers are already widely known. Thus, U.S. Pat. No. 4,376,185 describes for example linear polyester-polysiloxane block copolymers. U.S. Pat. Nos. 3,778,458 and 4,613,641 describe inter alia side-chain-modified polyester-polysiloxane graft copolymers for use as surface-active additives in PU foams.

U.S. Pat. Nos. 4,613,641, 5,235,003, JP59207922A, and EP-A 0217364 describe polyester-polysiloxane block copolymers produced by ring-opening polymerization of cyclic esters with polysiloxanes endcapped with hydroxyalkyl groups. EP-A 0473812 discloses polyester-polysiloxane block copolymers produced by ring-opening polymerization of cyclic esters with polysiloxanes endcapped with aminoalkyl groups. Besides the use of polyester-polysiloxane copolymers as an additive in polyurethane foams and as an additive for paint formulations, they have also been investigated inter alia as an additive in the processing of thermoplastic polymers. In this case, the polar, aliphatic polyester component should ensure compatibility with the generally polar thermoplastic, whereas the polysiloxane component should assume the role of internal and external lubricant and can optionally modify the surface of a processed product.

EP-A 2616512 describes the use of polyester-polysiloxane copolymers in thermoplastic polymethyl methacrylates and polymethyl methacrylate molding compounds to improve the surface properties. In the series of preferred compounds, both linear and laterally-functionalized polyester-polysiloxane copolymers are used here. DE 102004035835 A describes the use of linear polyester-polysiloxane copolymers in thermoplastic, especially aromatic, polyester molding compounds in order to ensure better demoldability in the injection-molding process of the polyester molding compounds thus treated.

JP 2099558 A2 likewise describes polyester-polysiloxane copolymers in thermoplastic, aromatic polyester molding compounds so as to ensure better impact strength.

In EP-A 1211277, linear polyester-polysiloxane copolymers undergo reactive functionalization with anhydride-functional polyolefins; however, very large amounts of polyester-polysiloxane copolymers are used in some cases here and the lubricating effect of the polysiloxane is of course reduced by the chemical bonding to the anhydride-functional polyolefin.

Yilgör et al. describe in Journal of Applied Polymer Science, vol. 83, 1625-1634 (2002) the influence of linear polyester-polysiloxane block copolymers on the processing properties of polyolefins such as high-density polyethylene (HDPE) or polypropylene PP. However, it is found here that the influence of the linear polyester-polysiloxane block copolymers is poorer than that of other linear polysiloxane copolymers.

The invention provides compositions comprising
(A) polyolefins, which may optionally be substituted, and also
(B) at least one organosilicon compound of general formula

R_{3-a-b}(OR¹)ₐR²_{b}Si[OSiR₂]ₚ[OSiRR²]_{q}[OSiR²₂]ᵣOSiR_{3-a-b}(OR¹)ₐR²_{b} (I),
where
R may be identical or different and is a monovalent, optionally substituted, SiC-bonded hydrocarbon radical,
R¹ may be identical or different and is a hydrogen atom or a monovalent, optionally substituted hydrocarbon radical,
R² denotes a SiC-bonded polyester unit of general formula

R⁵—[O—(CR³₂)ₙ—CO—]ₘ—X—R⁴— (II)
in which
X is —O— or —NR^{x}—,
R³ may be identical or different and is a hydrogen atom or monovalent, optionally substituted hydrocarbon radicals,
R⁴ is divalent, optionally substituted hydrocarbon radicals having 1 to 40 carbon atoms, wherein individual carbon atoms may be replaced by oxygen atoms or —NR^{z}—.
R⁵ is a hydrogen atom or monovalent, optionally substituted hydrocarbon radicals having 1 to 40 carbon atoms, wherein individual carbon atoms may be replaced by oxygen atoms or carbonyl groups —CO— or organosilyl radicals.
R^{x} is a hydrogen atom or monovalent, optionally substituted hydrocarbon radicals having 1 to 20 carbon atoms, wherein individual carbon atoms may be replaced by oxygen atoms or organosilyl radicals —SiR′₃, in which R′ represent identical or different, monovalent, optionally substituted hydrocarbon radicals,
R^{z} is monovalent, optionally substituted hydrocarbon radicals having 1 to 20 carbon atoms, wherein individual carbon atoms may be replaced by oxygen atoms, polyester radicals R⁵—[O—(CR³₂)ₙ—CO—]ₘ— or organosilyl radicals —SiR′₃, in which R′ represent identical or different, monovalent, optionally substituted hydrocarbon radicals,
n is an integer from 3 to 6,
m is an integer from 1 to 100,
a is an integer from 0 to 3,
b is an integer from 0 to 1,
p is 0 or an integer from 1 to 1000,
q is 0 or an integer from 1 to 100, and
r is 0 or an integer from 1 to 100,
   with the proviso that a+b≤3 and q+r is an integer greater than 0.

Examples of substituted or unsubstituted polyolefins (A) used in accordance with the invention are low- and high-density polyethylenes (LDPE, LLDPE, HDPE), homopolymers of propylene (PP), copolymers of propylene with for example ethylene, butene, hexene, and octene (PPC), olefin copolymers such as ethylene-vinyl acetate copolymers (EVA), olefin copolymers such as ethylene-methyl acrylate copolymer (EMAC) or ethylene-butyl acrylate copolymers (EBAC), polyvinyl chloride (PVC) or polyvinyl chloride-ethylene copolymers, and also polystyrenes (PS, HIPS, EPS).

The polyolefins (A) used in accordance with the invention preferably contain units of general formula

[—CR⁶R⁷—CR⁸R⁹—]ₓ (III)

where R⁶, R⁷, R⁸, and R⁹ are each independently a hydrogen atom, saturated, optionally substituted hydrocarbon radicals, unsaturated hydrocarbon radicals, aromatic hydrocarbon radicals, vinyl ester radicals or a halogen atom and x is a number between 100 and 100 000.

Preferably, radicals R⁶, R⁷, R⁸, and R⁹ are each independently a hydrogen atom, saturated hydrocarbon radicals such as a methyl, butyl or hexyl radical, aromatic hydrocarbon radicals such as a phenyl radical, or halogen atoms such as chlorine or fluorine, particular preference being given to a hydrogen atom, methyl radical or chlorine atom.

The polyolefins (A) are particularly preferably polymers selected from the group consisting of polypropylene (PP), high-density polyethylene (HDPE), low-density polyethylene (LDPE), linear low-density polyethylene (LLDPE), polyvinyl chloride (PVC), polystyrene (PS), and polyvinylidene fluoride (PVDF).

Preferred monomers for the production of component (A) are ethylene, propylene, vinyl chloride, vinyl acetate, styrene, 1-butene, 1-hexene, 1-octene or butadiene or mixtures thereof, more preferably ethylene, propylene or vinyl chloride.

The polyolefins (A) used in accordance with the invention are preferably thermoplastic, meaning that the temperature at which the loss factor (G″/G′) in accordance with DIN EN ISO 6721-2:2008 has a value of 1 is preferably at least 40° C., more preferably at least 100° C.

The polymeric structure of the polyolefins (A) can be linear but also branched.

The nature of the organic polymers (A) used essentially determines the processing temperature of the mixture of the invention.

The proportion of the polyolefins (A) in the composition according to the invention is preferably 60% by weight to 99.99% by weight, particularly preferably 90% by weight to 99.9% by weight, very particularly preferably 97.5% by weight to 99.9% by weight.

The component (A) used in accordance with the invention is a commercially available product or it can be produced by standard chemical processes.

Examples of R are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl and cycloheptyl radical and methylcyclohexyl radicals; alkenyl radicals such as the vinyl, 1-propenyl and 2-propenyl radical; aryl radicals such as the phenyl, naphthyl, anthryl and phenanthryl radical; alkaryl radicals such as o-, m-, p-tolyl radicals; xylyl radicals and ethylphenyl radicals; or aralkyl radicals such as the benzyl radical or the α- and β-phenylethyl radicals.

Examples of halogenated radicals R are haloalkyl radicals such as the 3,3,3-trifluoro-n-propyl radical, the 2,2,2,2′,2′,2′-hexafluoroisopropyl radical and the heptafluoroisopropyl radical.

The radical R is preferably a monovalent hydrocarbon radical having 1 to 20 carbon atoms, optionally substituted by fluorine and/or chlorine atoms, more preferably a hydrocarbon radical having 1 to 6 carbon atoms, especially the methyl, ethyl, vinyl or phenyl radical.

Examples of radical R¹ are the radicals specified for the radical R and also polyalkylene glycol radicals attached via a carbon atom.

The radical R¹ is preferably hydrocarbon radicals, more preferably hydrocarbon radicals having 1 to 8 carbon atoms, especially the methyl or ethyl radical.

Examples of radical R³ are the radicals specified for radical R.

The radical R³ is preferably a hydrogen atom, methyl radicals or ethyl radicals, more preferably a hydrogen atom.

Examples of divalent residue R⁴ are alkylene radicals such as the methylene, ethylene, n-propylene, isopropylene, n-butylene, isobutylene, tert-butylene, n-pentylene, isopentylene, neopentylene, tert-pentylene, hexylene, heptylene, octylene, nonylene, decylene, dodecylene or octadecylene radicals; cycloalkylene radicals such as the cyclopentylene radical, 1,4-cyclohexylene radical, isophoronylene radical or 4,4′-methylenedicyclohexylene radical; alkenylene radicals such as the vinylene, n-hexenylene, cyclohexenylene, 1-propenylene, allylene, butenylene or 4-pentenylene radical; alkynylene radicals such as the ethynylene or propargylene radical; arylene radicals such as the phenylene, bisphenylene, naphthylene, anthrylene or phenanthrylene radical; alkarylene radicals such as the o-, m-, p-tolylene radicals, xylylene radicals or ethylphenylene radicals; or aralkylene radicals such as the benzylene radical, the 4,4′-methylenediphenylene radical, the α- or β-phenylethylene radical; substituted alkylene radicals such as the ethylene-propylene ether radical, ethylene-methylene ether radical, polyethylene oxide-propylene ether radical, polypropylene oxide-propylene ether radical, polyethylene oxide-co-polypropylene oxide-propylene ether radical, ethylene-propylenamine radical or the ethylene-methylenamine radical.

Preferably, radical R⁴ is alkylene radicals or substituted alkylene radicals, more preferably methylene radicals, n-propylene radicals, ethylene-propylene ether radicals or ethylene-propyleneamine radicals, especially alkylene radicals.

Examples of radical R⁵ are a hydrogen atom, alkyl radicals, triorganylsilyl radicals such as the trimethylsilyl radical, or hydrocarbon radicals substituted with carbonyl groups, such as the acetyl radical.

The radical R⁵ is preferably a hydrogen atom or acetyl radicals, more preferably a hydrogen atom.

Examples of radicals R^{x} and R^{z} are each independently the radicals specified above for the radical R.

The radical R^{x} is preferably a hydrogen atom or alkyl radicals, more preferably a hydrogen atom.

The radical R^{z} is preferably alkyl radicals or aliphatic polyester radicals, more preferably aliphatic polyester radicals.

X preferably denotes —NR^{x}—, where R^{x} is as defined above.

Examples of radical R′ are the radicals specified for radical R.

The radical R′ is preferably alkyl radicals, more preferably the methyl radical.

Index m is preferably values from 1 to 50, more preferably values from 1 to 30.

Index n is preferably values of 4 or 5, more preferably 5.

Examples of radical R² are
H—[O—(CH₂)₅—CO—]₅—O—(CH₂)₃—,
H—[O—(CH₂)₅—CO—]₁₅—O—(CH₂)₃—,
H—[O—(CH₂)₅—CO—]₂₅—O—(CH₂)₃—,
H—[O—(CH₂)₃—(CHCH₃)₁—(C(CH₃)₂)₁—CO—]₁₅—O—(CH₂)₃—,
H—-[O—(CH₂)₃—CO—]₅—O—(CH₂)₃—,
H—[O—(CH₂)₃—CO—]₁₅—O—(CH₂)₃—,
H—[O—(CH₂)₅—CO—]₅—NH—(CH₂)₃—,
H—[O—(CH₂)₅—CO—]₁₅—NH—(CH₂)₃—,
H—[O—(CH₂)₃—(CHCH₃)₁—(C(CH₃)₂)₁—CO—]₁₅—NH—(CH₂)₃—,
H—[O—(CH₂)₃—CO—]₅—NH—(CH₂)₃—,
H—[O—(CH₂)₃—CO—]₁₅—NH—(CH₂)₃—,
H—[O—(CH₂)₅—CO—]₅—O—(CH₂)₂—O—(CH₂)₃—,
H—[O—(CH₂)₅—CO—]₁₅—O—(CH₂)₂—O—(CH₂)₃—,
H—[O—(CH₂)₃—(CHCH₃)₁—(C(CH₃)₂)₁—CO—]₁₅—O—(CH₂)₂—O—(CH₂)₃—,
H—[O—(CH₂)₃—CO—]₅—O—(CH₂)₂—O—(CH₂)₃—,
H—[O—(CH₂)₃—CO—]₁₅—O—(CH₂)₂—O—(CH₂)₃—,
H₃CCO—[O—(CH₂)₅—CO—]₅—O—(CH₂)₃—,
H₃CCO—[O—(CH₂)₅—CO—]₁₅—O—(CH₂)₃—,
H₃CCO—[O—(CH₂)₃—(CHCH₃)₁—(C(CH₃)₂)₁—-CO—]₁₅—O—(CH₂)₃—,
H₃CCO—[O—(CH₂)₃—CO—]₅—O—(CH₂)₃—,
H₃CCO—[O—(CH₂)₃—CO—]₁₅—O—(CH₂)₃—,
H₃CCO—[O—(CH₂)₅—CO—]₅—NH—(CH₂)₃—,
H₃CCO—[O—(CH₂)₅—CO—]₁₅—NH—(CH₂)₃—,
H₃CCO—[O—(CH₂)₃—(CHCH₃)₁—(C(CH₃)₂)₁—CO—-]₁₅—NH—(CH₂)₃—,
H₃CCO—[O—(CH₂)₃—CO—]₅—NH—(CH₂)₃—,
H₃CCO—[O—(CH₂)₃—CO—]₁₅—NH—(CH₂)₃—,
H₃CCO—[O—(CH₂)₅—CO—]₅—O—(CH₂)₂—O—(CH₂)₃—,
H₃CCO—[O—(CH₂)₅—CO—]₁₅—O—(CH₂)₂—O—(CH₂)₃—,
H₃CCO—[O—(CH₂)₃—(CHCH₃)₁—(C(CH₃)₂)₁—CO—]₁₅—O—(CH₂)₂—O—(CH₂)₃—,
H₃CCO—[O—(CH₂)₃—CO—]₅—O—(CH₂)₂—O—(CH₂)₃—,
H₃CCO—[O—(CH₂)₃—CO—]₁₅—O—(CH₂)₂—O—(CH₂)₃—,
(H₃C)₃Si—[O—(CH₂)₅—CO—]₅—O—(CH₂)₃—,
(H₃C)₃Si—[O—(CH₂)₅—CO—]₁₅—O—(CH₂)₃—,
(H₃C)₃Si—[O—(CH₂)₃—(CHCH₃)₁—(C(CH₃)₂)₁—CO—]₁₅—O—(CH₂)₃—,
(H₃C)₃Si—[O—(CH₂)₃—CO—]₅—O—(CH₂)₃—,
(H₃C)₃Si—[O—(CH₂)₃—CO—]₁₅—O—(CH₂)₃—,
(H₃C)₃Si—[O—(CH₂)₅—CO—]₅—NH—(CH₂)₃—,
(H₃C)₃Si—[O—(CH₂)₅—CO—]₁₅—NH—(CH₂)₃—,
(H₃C)₃Si—[O—(CH₂)₃—(CHCH₃)₁—(C(CH₃)₂)₁—CO—-]₁₅—NH—(CH₂)₃—,
(H₃C)₃Si—[O—(CH₂)₃—CO—]₅—NH—(CH₂)₃13 , and
(H₃C)₃Si—[O—(CH₂)₃—CO—]₁₅—NH—(CH₂)₃—,
   with preference given to
H—[O—(CH₂)₅—CO—]₅—O—(CH₂)₃—,
H—[O—(CH₂)₅—CO—]₁₅—O—(CH₂)₃—,
H—[O—(CH₂)₅—CO—]₅—NH—(CH₂)₃—,
H—[O—(CH₂)₅—CO—-]₁₅—NH—(CH₂)₃—,
H—[O—(CH₂)₅—CO—]₅—O—(CH₂)₂—O—(CH₂)₃—,
H—[O—(CH₂)₅—CO—]₁₅—O—(CH₂)₂—O—(CH₂)₃—,
H₃CCO—[O—(CH₂)₅—CO—]₅—O—(CH₂)₃—,
H₃CCO—[O—(CH₂)₅—CO—]₁₅—O—(CH₂)₃—,
H₃CCO—[O—(CH₂)₅—CO—]₅—NH—(CH₂)₃—,
H₃CCO—[O—(CH₂)₅—CO—]₁₅—NH—(CH₂)₃—,
H₃CCO—[O—(CH₂)₅—CO—]₅—O—(CH₂)₂—O—(CH₂)₃—,
H₃CCO—[O—(CH₂)₅—CO—]₁₅—O—(CH₂)₂—O—(CH₂)₃—,
(H₃C)₃Si—[O—(CH₂)₅—CO—]₅—O—(CH₂)₃—,
(H₃C)₃Si—[O—(CH₂)₅—CO—]₁₅—O—(CH₂)₃—,
(H₃C)₃Si—[O—(CH₂)₅—CO—]₅—NH—(CH₂)₃—0 or
(H₃C)₃Si—[O—(CH₂)₅—CO—]₁₅—NH—(CH₂)₃—
   and particular preference to
H—[O—(CH₂)₅—CO—]₁₅—O—(CH₂)₃—,
H—[O—(CH₂)₅—CO—]₁₅—NH—(CH₂)₃—,
H—[O—(CH₂)₅—CO—]₁₅—O—(CH₂)₂—O—(CH₂)₃—,
H₃CCO—[O—(CH₂)₅—CO—]₁₅—O—(CH₂)₃—,
H₃CCO—[O—(CH₂)₅—CO—]₁₅—NH—(CH₂)₃— or
H₃CCO—[O—(CH₂)₅—CO—]₁₅—O—(CH₂)₂—O—(CH₂)₃—
a is preferably 0 or 1, more preferably 0.
b is preferably 0 or 1, more preferably 0.
p is preferably an integer from 10 to 500, more preferably an integer from 20 to 200.
q is preferably an integer from 1 to 20, more preferably an integer from 1 to 10.
r is preferably 0 or an integer from 1 to 10, more preferably 0 or an integer from 1 to 5, especially 0.

The organosilicon compounds of formula (I) used in accordance with the invention preferably have an average molecular weight Mn of 1000 g/mol to 40 000 g/mol and more preferably an average molecular weight Mn of 2000 g/mol to 15 000 g/mol.

The number-average molar mass Mn is determined in the context of the present invention by size-exclusion chromatography (SEC) on a Styragel HR3-HR4-HR5-HR5 column set from Waters Corp. USA in THF with an injected volume of 100 μl against a polystyrene standard at 60° C., a flow rate of 1.2 ml/min, and detection by RI (refractive index detector).

The organosilicon compounds of formula (I) preferably have a melting point of below 200° C., particularly preferably of below 100° C., very particularly preferably of below 75° C., in each case at 1013 hPa.

The silicon content of the organosilicon compounds of general formula (I) is preferably 5% to 30% by weight, more preferably 10% to 25% by weight.

The organosilicon compounds of formula (I) used in accordance with the invention are preferably

R₃Si[OSiR₂]ₚ[OSiRR²]_{q}OSiR₃, where
R=methyl, R²=H—[O—(CH₂)₅—CO—]₁₅—O—(CH₂)₃—, p=45, q=2,
R=methyl, R²=H—[O—(CH₂)₅—CO—]₁₃—O—(CH₂)₃—, p=30, q=1,
R=methyl, R²=H—[O—(CH₂)₅—CO—]₂₀—O—(CH₂)₃—, p=70, q=3,
R=methyl, R²=H—[O—(CH₂)₅—CO—]₂₀—NH—(CH₂)₃—, p=40, q=2,
R=methyl, R²=H—[O—(CH₂)₅—CO—]₁₃—NH—(CH₂)₃—, p=30, q=1,
R=methyl, R²=H—[O—(CH₂)₅—CO—]₂₅—NH—(CH₂)₃—, p=80, q=3,
R=methyl, R²=R₃Si—[O—(CH₂)₅—CO—]₁₅—O—(CH₂)₃—, p=45, q=2,
R=methyl, R²=H₃CCO—[O—(CH₂)₅—CO—]₁₃—O—(CH₂)₃—, p=30, q=1,
R=methyl, R²=H—[O—(CH₂)₅—CO—]₂₀—O—(CH₂)₂—O—(CH₂)₃—, p=50, q=2,
R=methyl, R²=H—[O—(CH₂)₅—CO—]₂₅—O—(CH₂)₂—O—(CH₂)₃—, p=50, q=2,
R=methyl, R²=R₃Si—[O—(CH₂)₅—CO—]₂₀—NH—(CH₂)₃—, p=40, q=2, or
R=methyl, R²=H₃CCO—[O—(CH₂)₅—CO—]₁₃—NH—(CH₂)₃—, p=30, q=1
   more preferably

R₃Si[OSiR₂]ₚ[OSiRR²]_{q}OSiR₃, where
R=methyl, R²=H—[O—(CH₂)₅—CO—]₁₅—NH—(CH₂)₃—, p=23, q=1,
R=methyl, R²=H—[O—(CH₂)₅—CO—]₈—NH—(CH₂)₃—, p=46, q=4 or
R=methyl, R²=H—[O—(CH₂)₅—CO—]₁₅—NH—(CH₂)₃—, p=46, q=2.

The organosilicon compounds (B) used in accordance with the invention are commercially available products or can be produced by standard methods in silicon chemistry as described in the prior art.

Component (B) is used in amounts of preferably 0.05% by weight to 40% by weight, more preferably 0.2% to 5% by weight, especially 0.25% by weight to 3% by weight, in each case based on the amount of component (A).

In addition to components (A) and (B), the compositions of the invention may contain other substances, for example inorganic fillers (C), organic or inorganic fibers (D), flame retardants (E), biocides (F), pigments (G), UV absorbers (H), and HALS stabilizers (I).

Examples of inorganic fillers (C) optionally used are chalk (calcium carbonate), kaolin, silicates, silica or talc.

Examples of fibers (D) optionally used in accordance with the invention are glass fibers, basalt fibers or wollastonite, preference being given to glass fibers or organic fibers such as aramid fibers, wood fibers or cellulose fibers.

When inorganic fibers (D) are used, this is in amounts of preferably from 1% to 50% by weight, more preferably from 5% to 35% by weight. The compositions of the invention preferably contain no component (D).

When organic fibers (D) are used, this is in amounts of preferably from 20% to 80% by weight, more preferably from 35% to 65% by weight. The compositions of the invention preferably contain no component (D).

Examples of flame retardants (E) optionally used in accordance with the invention are organic flame retardants based on halogenated organic compounds or inorganic flame retardants, for example aluminum hydroxide (ATH) or magnesium hydroxide.

When flame retardants (E) are used, preference is given to inorganic flame retardants such as ATH.

Examples of biocides (F) optionally used in accordance with the invention are inorganic fungicides such as borates, for example zinc borate, or organic fungicides, for example thiabendazole.

Examples of pigments (G) optionally used in accordance with the invention are organic pigments or inorganic pigments, for example iron oxides or titanium dioxide.

When pigments (G) are used, this is in amounts of preferably from 0.2% to 7% by weight, more preferably from 0.5% to 3% by weight.

Examples of UV absorbers (H) optionally used in accordance with the invention are benzophenones, benzotriazoles or triazines.

When UV absorbers (H) are used, preference is given to benzotriazoles or triazines.

Examples of HALS stabilizers (I) optionally used in accordance with the invention are for example piperidine or piperidyl derivatives and are available inter alia under the Tinuvin brand names from BASF SE, D-Ludwigshafen.

Preferably, the compositions according to the invention are ones comprising
(A) HDPE,
(B) R₃Si[OSiR₂]ₚ[OSiRR²]_{q}OSiR₃, where R=methyl, R²=H—[O—(CH₂)₅—CO—]₁₅—NH—(CH₂)₃—, p=23, q=1,
optionally (C) inorganic fillers,
optionally (D) organic or inorganic fibers,
optionally (E) flame retardants,
optionally (F) biocides,
optionally (G) pigments,
optionally (H) UV absorbers and
optionally (I) HALS stabilizers.

Further preferably, the compositions according to the invention are ones comprising
(A) HDPE,
(B) R₃Si[OSiR₂]ₚ[OSiRR²]_{q}OSiR₃, where R=methyl, R²=H—[O—(CH₂)₅—CO—]₈—NH—(CH₂)₃—, p=46, q=4,
(D) inorganic fibers,
(G) pigments, and
(I) HALS stabilizers.

Particularly preferably, the compositions according to the invention are ones comprising
(A) HDPE,
(B) R₃Si[OSiR²]ₚ[OSiRR²]_{q}OSiR₃, where R=methyl, R²=H—[O—(CH₂)₅—CO—]₁₅—NH—(CH₂)₃—, p=46, q=2,
(D) organic fibers,
(F) biocides,
(G) pigments,
(H) UV absorbers, and
(I) HALS stabilizers.

Further preferably, the compositions according to the invention are ones comprising
(A) HDPE,
(B) R₃Si[OSiR₂]ₚ[OSiRR²]_{q}OSiR₃, where R=methyl, R²=H—[O—(CH₂)₅—CO—]₁₅—NH—(CH₂)₃—, p=46, q=2,
(C) inorganic fillers,
(G) pigments, and
(I) HALS stabilizers.

Further preferably, the compositions according to the invention are ones comprising
(A) HDPE,
(B) R₃Si[OSiR₂]ₚ[OSiRR²]_{q}OSiR₃, where R=methyl, R²=H—[O—(CH₂)₅—CO—]₈—NH—(CH₂)₃—, p=46, q=4, and
(G) pigments.

Further preferably, the compositions according to the invention are ones comprising
(A) LLDPE,
(B) R₃Si[OSiR₂]ₚ[OSiRR²]_{q}OSiR₃, where R=methyl, R²=H—[O—(CH₂)₅—CO—]₁₅—NH—(CH₂)₃—, p=23, q=1,
(C) inorganic fillers,
(E) flame retardants,
(G) pigments,
(H) UV absorbers, and
(I) HALS stabilizers.

Further preferably, the compositions according to the invention are ones comprising
(A) LLDPE,
(B) R₃Si[OSiR₂]ₚ[OSiRR²]_{q}OSiR₃, where R=methyl, R²=H—[O—(CH₂)₅—CO—]₈—NH—(CH₂)₃—, p=46, q=4,
(C) inorganic fillers,
(E) flame retardants, and
(I) HALS stabilizers.

Further preferably, the compositions according to the invention are ones comprising
(A) LLDPE,
(B) R₃Si[OSiR₂]ₚ[OSiRR²]_{q}OSiR₃, where R=methyl, R²=H—[O—(CH₂)₅—CO—]₁₅—NH-—(CH₂)₃—, p=46, q=2,
(C) inorganic fillers,
(D) inorganic fibers,
(G) pigments,
(H) UV absorbers, and
(I) HALS stabilizers.

Further preferably, the compositions according to the invention are ones comprising
(A) polypropylene,
(B) R₃Si[OSiR₂]ₚ[OSiRR²]_{q}OSiR₃, where R=methyl, R²=H—[O—(CH₂)₅—CO—]₁₅—NH—(CH₂)₃—, p=23, q=1,
(C) inorganic fillers,
(D) organic fibers,
(F) biocides,
(G) pigments,
(H) UV absorbers, and
(I) HALS stabilizers.

Further preferably, the compositions according to the invention are ones comprising
(A) polypropylene,
(B) R₃Si[OSiR₂]ₚ[OSiRR²]_{q}OSiR₃, where R=methyl, R²=H—[O—(CH₂)₅—CO—]₈—NH—(CH₂)₃—, p=46, q=4,
(D) inorganic fibers,
(E) flame retardants,
(G) pigments, and
(I) HALS stabilizers.

Further preferably, the compositions according to the invention are ones comprising
(A) polypropylene,
(B) R₃Si[OSiR₂]ₚ[OSiRR²]_{q}OSiR₃, where R=methyl, R²=H—[O—(CH₂)₅—CO—]₁₅—NH—(CH₂)₃—, p=46, q=2,
(D) organic fibers,
(F) biocides,
(G) pigments,
(H) UV absorbers, and
(I) HALS stabilizers.

In a further particularly preferred embodiment, the compositions according to the invention are ones comprising
(A) polypropylene,
(B) R₃Si[OSiR₂]ₚ[OSiRR²]_{q}OSiR₃, where R=methyl, R²=H—[O—(CH₂)₅—CO—]₁₅—NH—(CH₂)₃—, p=46, q=2,
(D) inorganic fibers, and
(I) HALS stabilizers.

Further preferably, the compositions according to the invention are ones comprising
(A) polyvinyl chloride,
(B) R₃Si[OSiR₂]ₚ[OSiRR²]_{q}OSiR₃, where R=methyl, R²=H—[O—(CH₂)₅—CO—]₁₅—NH—(CH₂)₃—, p=23, q=1,
(C) inorganic fillers, and
(G) pigments.

The compositions of the invention preferably contain no further constituents over and above components (A) to (I).

The individual constituents of the compositions of the invention may in each case be one kind of such a constituent or else a mixture of at least two different kinds of such constituents.

The compositions of the invention may be produced by any existing known process, such as mixing the components in any desired order. Mixers or kneaders or extruders of the prior art may be used for this purpose.

The present invention further provides a process for producing the compositions of the invention by mixing components (A) and (B) and optionally further components, preferably selected from components (C) to (I), in any desired order.

The process of the invention may take place in the presence or absence of a solvent, preference being given to solvent-free production.

The process of the invention may be carried out continuously, discontinuously or semicontinuously, but preferably continuously.

The process of the invention is preferably carried out in continuously operated kneaders or mixers or extruders, wherein the individual components to be mixed according to the invention are each continuously supplied to the mixing unit gravimetrically or volumetrically, either in pure form or as a premix. Components present in the overall mixture in a proportion of less than 1% by weight are preferably supplied as a premix in one of the components present in a larger proportion.

The temperatures at which the process of the invention is carried out depend primarily on the components used and are known to those skilled in the art, with the proviso that they are below the specific decomposition temperatures of the individual components used. The process of the invention is preferably carried out at temperatures below 250° C., more preferably within a range from 150 to 220° C.

The process of the invention is preferably carried out at the pressure of the surrounding atmosphere, that is to say between 900 and 1100 hPa. However, higher pressures may also be employed, depending in particular on the mixing unit used. For instance, the pressure in different areas of the kneaders, mixers or extruders used is for example significantly greater than 1000 hPa.

In a preferred embodiment of the process of the invention, component (B) is employed in what is known as a masterbatch, in the form of a premix with part of the polyolefin (A) and optionally one or more of components (C) to (I). This premix is preferably produced by mixing components (A) and (B) and optionally one or more of components (C) to (I) at temperatures between 140° C. and 230° C., it being possible for mixing to be carried out continuously, discontinuously or semicontinuously. Mixers, kneaders or extruders of the prior art may be used for the mixing process.

Components (A) and (B) are preferably mixed continuously in an extruder or kneader of the prior art. The copolymer (B) is present in this premix in an amount preferably between 5% and 35% by weight, more preferably between 10% and 30% by weight, especially preferably between 10% and 25% by weight, in each case based on the weight of the premix.

The premix produced according to the invention is preferably present in the form of pellets or powder, but preferably in the form of pellets. The pellets may also be processed into a powder by mechanical grinding or obtained as micropellets via an appropriate pelletization unit.

In the process of the invention, the premix thus obtained is then conveyed, preferably continuously, to a heatable mixer along with the remaining portions of component (A) and optionally one or more of components (C) to (I). The components may here be added to the mixer separately or added together.

The individual components are then mixed/homogenized at temperatures of preferably from 150 to 240° C., more preferably at 180 to 210° C.

After the operation of mixing the individual components, the composition of the invention is then preferably discharged from the reactor via a die in the form of a hot melt of high viscosity. In a preferred process, the material is after exit cooled by means of a cooling medium and then comminuted/granulated. The cooling of the material and the pelletization can here be accomplished simultaneously through underwater pelletization, or one after the other. Either water or air are used as preferred cooling media. Preferred methods of pelletization are underwater pelletization, pelletization by air cutting or strand pelletization. The pellets obtained have a weight of preferably less than 0.5 g, more preferably less than 0.25 g, especially less than 0.125 g. Preferably, the pellets obtained according to the invention are cylindrical or spherical.

The pellets thus obtained may be extruded in a subsequent step by means of further thermoplastic processing to form a molding, preferably a profile. According to a preferred procedure, the compositions of the invention are continuously conveyed in pellet form into a kneader or extruder of the prior art, heated and plasticized in this kneader or extruder through the influence of temperature, and then pressed through a die that dictates the desired profile shape. Depending on the design of the die, it is possible for either solid profiles or hollow profiles to be produced here.

The invention further provides moldings produced by extrusion of the compositions of the invention or by processing by means of an injection-molding process.

In a preferred embodiment, the composition of the invention is extruded directly, via an appropriate die, continuously in the form of a profile or film, which can then—likewise after cooling—be trimmed and/or cut to length.

The composition of the invention may be produced using mixers or kneaders or extruders of the prior art.

The compositions obtained according to the invention are preferably thermoplastic, meaning that the temperature at which the loss factor (G″/G′) in accordance with DIN EN ISO 6721-2:2008 has a value of 1 is preferably at least 40° C., more preferably at least 100° C.

The mixtures of the invention can be used anywhere that mixtures with polyolefins have also been employed to date.

The mixtures according to the invention can be used to produce semifinished products such as films, pipes, cable claddings, panels, profiles or fibers or to produce 3-dimensional molded parts.

The compositions of the invention have the advantage of being easy to produce.

When these compositions are continuously processed into semifinished products, the compositions of the invention have the advantage of affording products that exhibit better surface quality, that may exhibit improved abrasion resistance, that have lower surface energies, and that show improved mechanical characteristics. Surprisingly, it was found that straight side-chain functionalized aliphatic polyester-polysiloxane graft copolymers exhibit a significantly improved lubricating effect in polyolefins compared to linear polyester-polysiloxane block copolymers of comparable chemical composition or compared to other organic process additives optimized for processing polyolefins. Moreover, these semifinished products can be extruded at higher speed. The production of 3-dimensional moldings from the compositions of the invention has the advantage that these exhibit increased abrasion resistance, that the processing process can be accelerated on account of the increased flowability of the material, that adhesion to the mold can be reduced, thus allowing demolding forces and demolding times to be reduced, that thinner-walled parts lighter in weight can be produced, and that the surface quality of the moldings produced from the mixtures of the invention is significantly better, allowing the prevention of rheological effects such as “tiger stripes” that occur during the injection-molding process.

The compositions of the invention have the advantage that it is now possible for easy-flowing polymers having poorer mechanical characteristics to be replaced with more poorly flowing polymers having better mechanical characteristics, thereby allowing the mechanical characteristics of the compositions to be improved overall.

The use of fillers in the compositions of the invention has the advantage that the content of fillers may be increased slightly to improve the property profile without this affecting processability. The mixtures of the invention make it possible to avoid damage to anisotropic fillers such as fibers, which results in an improved property profile.

In the examples described below, all viscosity data are based on a temperature of 25° C. Unless otherwise stated, the examples that follow are carried out at a pressure of the surrounding atmosphere, that is to say at around 1000 hPa, and at a temperature of 20° C., or at a temperature that results when combining the reactants at room temperature without supplemental heating or cooling, and at a relative humidity of about 50%. In addition, unless otherwise stated, all reported parts and percentages relate to weight.

### Reactants:

Siloxane 1: α,ω-OH-terminated polydimethylsiloxane having an Si—OH content of 3.8% by weight;
Siloxane 2: α,ω-trimethylsilyl-terminated polydimethylsiloxane having a viscosity of 4.6 mPas;
Processing aids (P1): “Struktol TPW 104” commercially available from Schill-und Seilacher, D-BÖblingen;
Processing aids (P2): “Struktol TPW 113” commercially available from Schill-und Seilacher, D-Böblingen;
Hordaphos MDIT: Phosphoric acid isotridecyl ester from Clariant, D-Frankfurt am Main.

### 1) Preparation of a Siloxane Having Lateral Amino Groups (A1)

A 4-liter 3-necked flask was charged with 104.6 g of aminopropyldiethoxysilane (191 g/mol), 788.7 g of siloxane 1, and 438.2 g of siloxane 2 and this was mixed at room temperature while stirring with a KPG stirrer. After 1 h, the mixture was heated gradually to 130° C.; on reaching 130° C., the pressure was lowered to 300 hPa for 1 h, as a result of which a water-ethanol mixture slowly distilled off. The pressure was then raised back to standard pressure and the temperature was lowered to 90° C. 1.3 g of potassium hydroxide was then added in the form of a 20% methanol solution (1000 ppm KOH), the pressure was gradually lowered again to 300 hPa, and the temperature was increased to 130° C. for 8 h, affording cyclic siloxanes as a distillate.

The pressure was then raised again to standard pressure with nitrogen, and 1.0 g of Hordaphos MDIT was added to neutralize the potassium hydroxide. The mixture was then heated to 150° C. with stirring and at a reduced pressure of 2 hPa, and further cyclic siloxanes distilled off. This afforded as the product 1081.3 g of a clear, colorless polydimethylsiloxane functionalized in the side chain with aminopropyl groups and having an amine value of 25.5 mg KOH/g, and 215.6 g of cyclic siloxanes as a side product.

### 2) Preparation of a Siloxane Having Lateral Amino Hgroups (A2)

A 4-liter 3-necked flask was charged with 192.4 g of aminopropyldiethoxysilane (191 g/mol) and 40.0 g of water and this was mixed at room temperature while stirring with a KPG stirrer. After 1 h, 967.3 g of siloxane 1 and 201.5 g of siloxane 2 were added and the mixture was heated gradually to 130° C.; on reaching 130° C., the pressure was lowered to 300 hPa for 1 h, as a result of which a water-ethanol mixture slowly distilled off. The pressure was then raised back to standard pressure and the temperature was lowered to 90° C. 1.4 g of potassium hydroxide was then added in the form of a 20% methanol solution (1000 ppm KOH), the pressure was gradually lowered again to 300 hPa, and the temperature was increased to 130° C. for 8 h, affording cyclic siloxanes as a distillate. The pressure was then raised again to standard pressure with nitrogen, and 1.0 g of Hordaphos MDIT was added to neutralize the potassium hydroxide. The mixture was then heated to 150° C. with stirring and at a reduced pressure of 2 hPa, and further cyclic siloxanes distilled off. This afforded as the product 1047.0 g of a clear, colorless polydimethylsiloxane functionalized in the side chain with aminopropyl groups and having an amine value of 48.7 mg KOH/g, and 253.6 g of cyclic siloxanes as a side product.

### 3) Preparation of a Siloxane Having Lateral Amino Groups (A3)

A 4-liter 3-necked flask was charged with 104.6 g of aminopropyldiethoxysilane (191 g/mol), 1051.6 g of siloxane 1, and 219.1 g of siloxane 2 and this was mixed at room temperature while stirring with a KPG stirrer. After 1 h, the mixture was heated gradually to 130° C.; on reaching 130° C., the pressure was lowered to 300 hPa for 1 h, as a result of which a water-ethanol mixture slowly distilled off. The pressure was then raised back to standard pressure and the temperature was lowered to 90° C. 1.4 g of potassium hydroxide was then added in the form of a 20% methanol solution (1000 ppm KOH), the pressure was gradually lowered again to 300 hPa, and the temperature was increased to 130° C. for 8 h, affording cyclic siloxanes as a distillate. The pressure was then raised again to standard pressure with nitrogen, and 1.0 g of Hordaphos MDIT was added to neutralize the potassium hydroxide. The mixture was then heated to 150° C. with stirring and at a reduced pressure of 2 hPa, and further cyclic siloxanes distilled off. This afforded as the product 1063.2 g of a clear, colorless polydimethylsiloxane functionalized in the side chain with aminopropyl groups and having an amine value of 25.5 mg KOH/g, and 250.7 g of cyclic siloxanes as a side product.

### 4) Preparation of a Siloxane Having Aliphatic Polyester Side Chains (A4)

125 g of polydimethylsiloxane (A1) functionalized with aminopropyl groups in the side chain was in a 500 g 3-necked flask heated together with 0.25 g of tin(II) ethylhexanoate and 125 of ε-caprolactone for about 1 h at 80° C. while stirring with a KPG stirrer. The reaction mixture was then heated to 140° C. while stirring and stirred at 140° C. for 3 h. Finally, 2.2 g of residual ε-caprolactone was distilled off at 140° C. using a distillation bridge while stirring for 30 minutes at a pressure of 5 hPa and the product was poured out while warm in the form of a melt and then pastillized. 246.3 g of a polydimethylsiloxane-poly-ε-caprolactone graft copolymer having a melting point of 53° C. and a siloxane content of 50% is obtained.

### 5) Preparation of a Siloxane Having Aliphatic Polyester Side Chains (A5)

125 g of polydimethylsiloxane (A2) functionalized with aminopropyl groups in the side chain was in a 500 ml 3-necked flask heated together with 0.25 g of tin(II) ethylhexanoate and 125 g of ε-caprolactone for about 1 h at 80° C. while stirring with a KPG stirrer. The reaction mixture was then heated to 140° C. while stirring and stirred at 140° C. for 3 h. Finally, 1.5 g of residual ε-caprolactone was distilled off at 140° C. using a distillation bridge while stirring for 30 minutes at a pressure of 5 hPa and the product was poured out while warm in the form of a melt and then pastillized. 247.6 g of a polydimethylsiloxane-poly-ε-caprolactone graft copolymer having a melting point of 52° C. and a siloxane content of 50% is obtained.

### 6) Preparation of a Siloxane Having Aliphatic Polyester Side Chains (A6)

125 g of polydimethylsiloxane (A3) functionalized with aminopropyl groups in the side chain was in a 500 ml 3-necked flask heated together with 0.25 g of tin(II) ethylhexanoate and 125 g of ε-caprolactone for about 1 h at 80° C. while stirring with a KPG stirrer. The reaction mixture was then heated to 140° C. while stirring and stirred at 140° C. for 3 h. Finally, 3.1 g of residual ε-caprolactone was distilled off at 140° C. using a distillation bridge while stirring for 30 minutes at a pressure of 5 hPa and the product was poured out while warm in the form of a melt and then pastillized. 245.8 g of a polydimethylsiloxane-poly-ε-caprolactone graft copolymer having a melting point of 53° C. and a siloxane content of 50% is obtained.

### 7) Preparation of a Siloxane Having Aliphatic Polyester End Groups (A7)

125 g of a polydimethylsiloxane functionalized with an aminopropyl group at each chain end and having a molecular weight of 3230 g/mol was in a 500 ml 3-necked flask heated together with 0.25 g of tin(II) ethylhexanoate and 125 g of ε-caprolactone for about 1 h at 80° C. while stirring with a KPG stirrer. The reaction mixture was then heated to 140° C. while stirring and stirred at 140° C. for 3 h. Finally, 1.5 g of residual ε-caprolactone was distilled off at 140° C. using a distillation bridge while stirring for 30 minutes at a pressure of 5 hPa and the product was poured out while warm in the form of a melt and then pastillized. 246.9 g of a polydimethylsiloxane-poly-ε-caprolactone block copolymer having a melting point of 51° C. and a siloxane content of 50% is obtained.

### EXAMPLES 1-4

The polyester-polysiloxane copolymers (A4) to (A6) produced above were in each case homogeneously mixed at room temperature with a high-density polyethylene (PE 1) (commercially available under the name “HDPE, Purell GA 7760” from LyondellBasell, D-Frankfurt) in the amounts specified in Table 1, the total amount of the respective mixture being 1000 g.

This mixture was then in each case compounded at a temperature of 195° C. in a counter-rotating twin-screw extruder from Collin. The temperature in the feed area (zone 1) was 95° C., which increased to 190° C. in zone 2 and zone 3 and further increased to 195° C. in zone 4 and zone 5. Zone 6 (die) was heated at 190° C. The mixture was extruded as a strand which was then pelletized. The screw rotation speed was 50 rpm. The discharge rate was about 1.5 kg/h.

The melt volume rate (MVR) of the polymer mixtures thus obtained was then determined in accordance with DIN ISO 1133 using an MFI tester from Göttfert (MI II) at a temperature of 175° C., a load weight of 2.16 kg, and a heating time of 5 minutes and with a die diameter of 2 mm. In each case, 3 measured values were determined and these were then averaged.

The results can be found in Table 1.

### Comparative Example C1

The procedure described in examples 1-4 is repeated, with the modification that none of the copolymers (A4) to (A6) was used. The results can be found in Table 1.

### Comparative Example C2

The procedure described in examples 1-4 is repeated, with the modification that processing aid (P1) in the amounts specified in Table 1 was used in place of copolymer (A4) to (A6). The results can be found in Table 1.

### Comparative Example C3

The procedure described in examples 1-4 is repeated, with the modification that processing aid (P2) was used in place of copolymer (A4) to (A6). The results can be found in Table 1.

### Comparative Example C4

The procedure described in examples 1-4 is repeated, with the modification that copolymer (A7) was used in place of copolymer (A4) to (A6). The results can be found in Table 1.

### Comparative Example C5

The procedure described in examples 1-4 is repeated, with the modification that processing aid (P1) in the amounts specified in Table 1 was used in place of copolymer (A4) to (A6). The results can be found in Table 1.

TABLE 1

| | | | | | | | | MVR |
|---|---|---|---|---|---|---|---|---|
| | (PE1) | (P1) | (P2) | (A4) | (A5) | (A6) | (A7) | [ml/ |
| Example | [g] | [g] | [g] | [g] | [g] | [g] | [g] | 10 min] |
| C1 | 1000 | | | | | | | 16.3 |
| C2 | 980 | 20 | | | | | | 20.4 |
| C3 | 980 | | 20 | | | | | 19.3 |
| 1 | 980 | | | 20 | | | | 26.9 |
| 2 | 980 | | | | 20 | | | 23.7 |
| 3 | 980 | | | | | 20 | | 24.3 |
| C4 | 980 | | | | | | 20 | 17.7 |
| 4 | 990 | | | 10 | | | | 18.3 |
| C5 | 960 | 40 | | | | | | 25.3 |

It can be seen that the laterally functionalized polyester-polysiloxane copolymers (A4), (A5), and (A6) in the mixtures in working examples 1-4 result in significantly higher flowabilities than, for example, a linear polyester-polysiloxane copolymer of comparative example C4 or commercial organic HDPE additives in comparative examples C2, C3, and C5. The copolymer from example 1 is about twice as effective as the commercial comparison product (P1) or the linear copolymer from comparison example C4, since the same effect is found here with only half the amount added.

### EXAMPLES 5-7

The polyester-polysiloxane copolymers (A4) to (A6) produced above were in each case homogeneously mixed at room temperature with a high-density polyethylene (PE 2) (commercially available under the name “HDPE, BB2581” from Borealis

Polyolefine, Linz) in the amounts specified in Table 1, the total amount of the respective mixture being 1000 g.

This mixture was then compounded at a temperature of 195° C. in a counter-rotating twin-screw extruder from Collin. The temperature in the feed area (zone 1) was 95° C., which increased to 190° C. in zone 2 and zone 3 and further increased to 195° C. in zone 4 and zone 5. Zone 6 (die) was heated at 195° C. The mixture was extruded as a strand which was then pelletized. The screw rotation speed was 50 rpm. The discharge rate was about 1.5 kg/h.

The melt volume rate (MVR) of the polymer mixtures thus obtained was then determined in accordance with DIN ISO 1133 using an MFI tester from Göttfert (MI II) 5 at a temperature of 190° C., a load weight of 10 kg, and a heating time of 5 minutes and with a die diameter of 2 mm. In each case, 3 measured values were determined and these were then averaged.

The results can be found in Table 2.

### Comparative Example C6

The procedure described in examples 5-7 is repeated, with the modification that none of the copolymers (A4) to (A6) was used. The results can be found in Table 2.

### Comparative Example C7

The procedure described in examples 5-7 is repeated, with the modification that processing aid (P1) in the amounts specified in Table 2 was used in place of copolymer (A4) to (A6). The results can be found in Table 2.

TABLE 2

| | (PE2) | (P1) | (A4) | (A5) | (A6) | MVR |
|---|---|---|---|---|---|---|
| Example | [g] | [g] | [g] | [g] | [g] | [ml/10 min] |
| C6 | 1000 | | | | | 5.8 |
| C7 | 960 | 40 | | | | 15.8 |
| 5 | 980 | | 20 | | | 19.0 |
| 6 | 980 | | | 20 | | 25.3 |
| 7 | 980 | | | | 20 | 21.9 |

### EXAMPLES 8-10

The polyester-polysiloxane copolymers (A4) to (A6) produced above were in each case homogeneously mixed at room temperature with a polypropylene homopolymer (PP 1) (commercially available under the name “HC205 TF” from Borealis Polyolefine, Linz) in the amounts specified in Table 3, the total amount of the respective mixture being 1000 g.

This mixture was then compounded at a temperature of 210° C. in a counter-rotating twin-screw extruder from Collin. The temperature in the feed area (zone 1) was 95° C., which increased to 190° C. in zone 2 and zone 3 and further increased to 205° C. in zone 4 and zone 5. Zone 6 (die) was heated at 200° C. The mixture was extruded as a strand which was then pelletized. The screw rotation speed was 50 rpm. The discharge rate was about 1.5 kg/h.

The melt volume rate (MVR) of the polymer mixtures thus obtained was then determined in accordance with DIN ISO 1133 using an MFI tester from Göttfert (MI II) at a temperature of 230° C., a load weight of 2.16 kg, and a heating time of 5 minutes and with a die diameter of 2 mm. In each case, 3 measured values were determined and these were then averaged.

The results can be found in Table 3.

### Comparative Example C8

The procedure described in examples 8-10 is repeated, with the modification that none of the copolymers (A4) to (A6) was used. The results can be found in Table 3.

### Comparative Example C9

The procedure described in examples 8-10 is repeated, with the modification that processing aid (P1) in the amounts specified in Table 3 was used in place of copolymer (A4) to (A6). The results can be found in Table 3.

TABLE 3

| | (PP1) | (P1) | (A4) | (A5) | (A6) | MVR |
|---|---|---|---|---|---|---|
| Example | [g] | [g] | [g] | [g] | [g] | [ml/10 min] |
| C8 | 1000 | | | | | 5.9 |
| C9 | 960 | 40 | | | | 7.3 |
| 8 | 980 | | 20 | | | 10.0 |
| 9 | 980 | | | 20 | | 11.2 |
| 10 | 980 | | | | 20 | 9.4 |

1-10. (canceled)

11. A composition, comprising:
(A) polyolefins, which may optionally be substituted, and also
(B) at least one organosilicon compound of general formula
R_{3-a-b}(OR¹)ₐR²_{b}Si[OSiR₂]ₚ[OSiRR²]_{q}[OSiR²₂]ᵣOSiR_{3-a-b}(OR¹)ₐR²_{b} (I),
wherein R may be identical or different and is a monovalent, optionally substituted, SiC-bonded hydrocarbon radical;
wherein R¹ may be identical or different and is a hydrogen atom or a monovalent, optionally substituted hydrocarbon radical;
wherein R² denotes a SiC-bonded polyester unit of general formula
R⁵[O—(CR³₂)ₙ—CO—]ₘ—X—R⁴— (II)
werein X is —O— or —NR^{x}—;
wherein R³ may be identical or different and is a hydrogen atom or monovalent, optionally substituted hydrocarbon radicals;
wherein R⁴ is divalent, optionally substituted hydrocarbon radicals having 1 to 40 carbon atoms and wherein individual carbon atoms may be replaced by oxygen atoms or —NR^{z}—;
wherein R⁵ is a hydrogen atom or monovalent, optionally substituted hydrocarbon radicals having 1 to 40 carbon atoms and wherein individual carbon atoms may be replaced by oxygen atoms or carbonyl groups —CO— or organosilyl radicals;
wherein R^{x} is a hydrogen atom or monovalent, optionally substituted hydrocarbon radicals having 1 to 20 carbon atoms, wherein individual carbon atoms may be replaced by oxygen atoms or organosilyl radicals —SiR′₃, in which R′ represent identical or different, monovalent, optionally substituted hydrocarbon radicals;
wherein R^{z} is monovalent, optionally substituted hydrocarbon radicals having 1 to 20 carbon atoms, wherein individual carbon atoms may be replaced by oxygen atoms, polyester radicals R⁵[O—(CR³₂)ₙ—CO—]ₘ— or organosilyl radicals —SiR′₃, in which R′ represent identical or different, monovalent, optionally substituted hydrocarbon radicals,
wherein n is an integer from 3 to 6;
wherein m is an integer from 1 to 100;
wherein a is an integer from 0 to 3;
wherein b is an integer from 0 to 1;
wherein p is 0 or an integer from 1 to 1000;
wherein q is 0 or an integer from 1 to 100;
wherein r is 0 or an integer from 1 to 100; and
wherein a+b≤3 and q+r is an integer greater than 0.

12. The composition of claim 11, wherein the polyolefins (A) used contain units of general formula
[—CR₆R⁷—CR⁸R⁹—]ₓ (III)
where R⁶, R⁷, R⁸, and R⁹ are each independently a hydrogen atom, saturated, optionally substituted hydrocarbon radicals, unsaturated hydrocarbon radicals, aromatic hydrocarbon radicals, vinyl ester radicals or a halogen atom and x is a number between 100 and 100 000.

13. The composition of claim 11, wherein the polyolefins (A) are polymers selected from the group consisting of polypropylene (PP), high-density polyethylene (HDPE), low-density polyethylene (LDPE), linear low-density polyethylene (LLDPE), polyvinyl chloride (PVC), polystyrene (PS), and polyvinylidene fluoride (PVDF).

14. The composition of claim 11, wherein the proportion of the polyolefins (A) is 60% by weight to 99.99% by weight.

15. The composition of claim 11, wherein a=b=0.

16. The composition of claim 11, wherein the component (B) is used in amounts of 0.05% by weight to 40% by weight based on the amount of component (A).

17. The composition of claim 11, wherein (A) is HDPE;
wherein (B) R₃Si[OSiR₂]ₚ[OSiRR²]_{q}OSiR₃ where R=methyl, R²=H—[O—(CH₂)₅—CO—]₁₅—NH—(CH₂)₃—, p=23, q=1; and
wherein the composition optionally comprises
(C) inorganic fillers,
(D) organic or inorganic fibers,
(E) flame retardants,
(F) biocides,
(G) pigments,
(H) UV absorbers, and/or
(I) HALS stabilizers.

18. The composition of claim 11, wherein the composition is a molding produced by extruding the composition using an injection molding process.

19. A process for producing a composition, the process comprising:
providing (A) polyolefins, which may optionally be substituted, and also
(B) at least one organosilicon compound of general formula
R_{3-a-b}(OR¹)ₐR²_{b}Si[OSiR₂]ₚ[OSiRR²]_{q}[OSiR²₂]ᵣOSiR_{3-a-b}(OR¹)ₐR²_{b} (I),
wherein R may be identical or different and is a monovalent, optionally substituted, SiC-bonded hydrocarbon radical;
wherein R¹ may be identical or different and is a hydrogen atom or a monovalent, optionally substituted hydrocarbon radical;
wherein R² denotes a SiC-bonded polyester unit of general formula
R⁵—[O—(CR³₂)ₙ—CO—]ₘ—X—R⁴— (II)
wherein X is —O— or —NR^{x}—;
wherein R³ may be identical or different and is a hydrogen atom or monovalent, optionally substituted hydrocarbon radicals;
wherein R⁴ is divalent, optionally substituted hydrocarbon radicals havinghu 1 to 40 carbon atoms and wherein individual carbon atoms may be replaced by oxygen atoms or —NR^{z}—;
wherein R⁵ is a hydrogen atom or monovalent, optionally substituted hydrocarbon radicals having 1 to 40 carbon atoms and wherein individual carbon atoms may be replaced by oxygen atoms or carbonyl groups —CO— or organosilyl radicals;
wherein R^{x} is a hydrogen atom or monovalent, optionally substituted hydrocarbon radicals having 1 to 20 carbon atoms, wherein individual carbon atoms may be replaced by oxygen atoms or organosilyl radicals —SiR′₃, in which R′ represent identical or different, monovalent, optionally substituted hydrocarbon radicals;
wherein R^{z} is monovalent, optionally substituted hydrocarbon radicals having 1 to 20 carbon atoms, wherein individual carbon atoms may be replaced by oxygen atoms, polyester radicals R⁵[O—(CR³₂)ₙ—CO—]ₘ— organosilyl radicals —SiR′₃, in which R′ represent identical or different, monovalent, optionally substituted hydrocarbon radicals,
wherein n is an integer from 3 to 6;
wherein m is an integer from 1 to 100;
wherein a is an integer from 0 to 3;
wherein b is an integer from 0 to 1;
wherein p is 0 or an integer from 1 to 1000;
wherein q is 0 or an integer from 1 to 100;
wherein r is 0 or an integer from 1 to 100; and
wherein a+b≤3 and q+r is an integer greater than 0;
mixing components (A) and (B) and optionally one or more additional components in ay desired order.

20. The process of claim 19, wherein the process is carried out continuously.

21. The process of claim 19, further comprising the step of extruding the composition using an injection molding process for form a molding.
